(19) United States
(12) Patent Application Publication
(10) Pub. No.: US 2026/0115627 A1
(43) Pub. Date: Apr. 30, 2026

(54) LIQUID-LIQUID SEPARATION SYSTEM AND METHOD OF SEPARATING A MIXTURE HAVING AQUEOUS PHASE AND ORGANIC PHASE

(71) Applicant: KING FAHD UNIVERSITY OF PETROLEUM AND MINERALS, Dhahran (SA)

(72) Inventors: Noor Tawfik ALARIFI, Dhahran (SA); Tawfik Abdo SALEH, Dhahran (SA)

(73) Assignee: KING FAHD UNIVERSITY OF PETROLEUM AND MINERALS, Dhahran (SA)

(21) Appl. No.: 18/930,253

(22) Filed: Oct. 29, 2024

(51) Int. Cl. B01D 17/04; C02F 1/40; C02F 101/32; C08J 5/00

(52) U.S. Cl. CPC B01D 17/045; C02F 1/40; C08J 5/005; C02F 2101/32; C08J 2323/12

(57) ABSTRACT

A liquid-liquid separation system including a mixing chamber, a hydrophilic separator connected to an aqueous phase outlet, and a hydrophobic separator connected to an organic phase outlet of the mixing chamber is provided. The hydrophilic separator includes a crown-ether-modified carbon nanomaterial having a carbon nanomaterial, and a crown-ether disposed on a surface of the carbon nanomaterial. The hydrophobic separator includes a hydrophobic polymer and fatty acid-modified metal oxide nanoparticles having a fatty acid disposed on a surface of metal oxide nanoparticles. The system receives a mixture stream including water and an organic chemical that is not miscible with water through a mixture inlet of the mixing chamber. The crown-ether-modified carbon nanomaterial allows water to pass therethrough while preventing the organic chemical and the fatty acid-modified metal oxide nanoparticles allow the organic chemical to pass therethrough while preventing water.

### BACKGROUND

### Technical Field

The present disclosure is directed to separation of an oil and water, and particularly relates to a liquid-liquid separation system having hydrophobic and hydrophilic separators and a method of separating a mixture having aqueous phase and organic phase.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Fossil fuel remains an integral part of world's economy and resources. However, in order to meet fossil fuel demands, rigorous exploitation of oil resources has occurred and is expected to continue to occur. Various industrial activities have resulted in oil-water combinations or mixtures that have contaminated the environment and subsequently, wasted valuable natural resources. A variety of other problems may arise from the aforementioned oil-water combinations or mixtures. For example, small amounts of fuel-containing water can condense on a metal surface of an internal combustion engine, causing corrosion that may drastically reduce a lifespan of the engine and increases the chance of failure. Further, water contributes to oxidation of petroleum products and the development of bio-contaminants in fuel. Nozzle and filter clogging, plunger seizure, and increased mechanical wear of injection pumps and injectors may occur due to the water-in-oil or water-in-fuel contamination. Further, some microorganisms proliferate due to water, carbon, nitrogen, and mineral nutrition. Typically, water must be present in order for microorganisms to grow. Even small amounts of water can cause issues, for example, if the water only appears in isolated pockets under a fuel. In some cases, a bottom of a fuel tank may be covered in microbial sludge, creating areas vulnerable to localized corrosion attacks.

In general, water can enter fuels or oils through precipitation, humidity, and condensation of air moisture. Fuels and oils can contain water in three different states including free water, emulsified water, and dissolved water. Therefore, a need arises for a method to separate oil-water mixtures.

Several technologies are present in the market for oil-water separation such as gravity-driven filtration, combustion, air flotation, biodegradation, and electrochemical approaches. In one example, removal or collection of the components after water absorption requires a long amount of time using a gravity-driven method since the wastewater must be pre-collected. In another example, combustion may achieve separation but at the cost of loss of the fuel or oil itself. Many of these methods are not compatible with a variety of oils or fuels. Hence, due to time-consuming operations and insufficient oil separation of traditional systems and methods for oil separation, they are unable to satisfy industry demand.

Each of the aforementioned systems and methods suffers from one or more drawbacks hindering their adoption. Accordingly, it is one object of the present disclosure to provide a liquid-liquid separation system and a method of separating an oil-water mixture.

### SUMMARY

According to a first aspect, the present disclosure relates to a liquid-liquid separation system. The liquid-liquid separation system includes a mixing chamber having a mixture inlet, an aqueous phase outlet, and an organic phase outlet. The liquid-liquid separation system further includes a hydrophilic separator connected to the aqueous phase outlet. The hydrophilic separator includes a crown-ether-modified carbon nanomaterial including a carbon nanomaterial, and a crown-ether disposed on a surface of the carbon nanomaterial. The liquid-liquid separation system further includes a hydrophobic separator connected to the organic phase outlet. The hydrophobic separator includes a hydrophobic polymer and a composite including fatty acid-modified metal oxide nanoparticles. The fatty acid-modified metal oxide nanoparticles include metal oxide nanoparticles having a fatty acid disposed on a surface of the metal oxide nanoparticles. The liquid-liquid separation system is configured to receive a mixture stream including water and an organic chemical that is not miscible with the water supplied to the mixture inlet of the mixing chamber. The crown-ether-modified carbon nanomaterial is hydrophilic and allows water to pass through the hydrophilic separator while preventing the organic chemical that is not miscible with the water from passing through the hydrophilic separator. The fatty acid-modified metal oxide nanoparticles are hydrophobic and allow the organic chemical that is not miscible with the water to pass through the hydrophobic separator while preventing the water from passing through the hydrophobic separator.

In some embodiments, the crown-ether is (18-Crown-6)-2,3,11,12-tetracarboxylic acid.

In some embodiments, the carbon nanomaterial is graphene oxide.

In some embodiments, the crown-ether-modified carbon nanomaterial has a weight ratio of carbon nanomaterial to crown-ether of 1:1 to 2.5:1.

In some embodiments, the hydrophilic separator has an oil contact angle of 125 to 175°.

In some embodiments, the metal oxide nanoparticles are alumina nanoparticles.

In some embodiments, the fatty acid is stearic acid.

In some embodiments, the hydrophobic polymer is polypropylene.

In some embodiments, the hydrophobic separator has a water contact angle of 125° to 175°.

In some embodiments, the liquid-liquid separation system includes a mixer.

In some embodiments, the aqueous phase outlet and the organic phase outlet are arranged in the mixing chamber such that the aqueous phase outlet is oriented at an aqueous outlet height lower than an organic outlet height at which the organic phase outlet is disposed.

The present disclosure also relates to, a method of separating a liquid-liquid mixture comprising an aqueous phase and an organic phase. The method includes introducing the liquid-liquid mixture into the mixing chamber of the liquid-liquid separation system. The method further includes collecting the aqueous phase from the aqueous phase outlet and collecting the organic phase from the organic phase outlet.

In some embodiments, the method includes forming the composite including the fatty acid-modified metal oxide nanoparticles and the hydrophobic polymer by heating a mixture of a metal hydroxide and a fatty acid to form fatty acid-modified metal oxide nanoparticles, and mixing the fatty acid-modified metal oxide nanoparticles and the hydrophobic polymer. The method includes disposing the composite including the fatty acid-modified metal oxide nanoparticles and the hydrophobic polymer in the hydrophobic separator.

In some embodiments, the metal hydroxide is aluminum hydroxide, the metal oxide nanoparticles are alumina nanoparticles, the fatty acid is stearic acid, and the hydrophobic polymer is polypropylene.

In some embodiments, the heating is performed by ultrasonication.

In some embodiments, the method includes forming the crown-ether-modified carbon nanomaterial by treating a carbon nanomaterial with an acid and a hydrogen peroxide to form an oxidized carbon nanomaterial and reacting the oxidized carbon nanomaterial with a crown ether carboxylic acid and a carbodiimide catalyst. The method further includes disposing the crown-ether-modified carbon nanomaterial in the hydrophilic separator.

In some embodiments, the acid is a mixture of phosphoric acid and sulfuric acid, the carbon nanomaterial is graphene, the oxidized carbon nanomaterial is graphene oxide, the crown ether carboxylic acid is (18-Crown-6)-2,3,11,12-tetracarboxylic acid, and the carbodiimide catalyst is N,N′-Dicyclohexylcarbodiimide.

In some embodiments, the mixture of phosphoric acid and sulfuric acid has a molar ratio of phosphoric acid to sulfuric acid of 0.01:1 to 0.25:1.

In some embodiments, the oxidized carbon nanomaterial with a crown ether carboxylic acid are reacted in a weight ratio of 1:1 to 2.5:1.

In some embodiments, the method has a separation efficiency of at least 90%.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A illustrates a schematic perspective view of a liquid-liquid separation system, according to certain embodiments.

FIG. 1B illustrates a schematic sectional view of the liquid-liquid separation system of FIG. 1A, according to certain embodiments.

FIG. 1C illustrates a schematic top view of the liquid-liquid separation system of FIG. 1A, according to certain embodiments.

FIG. 1D illustrates a schematic side view of the liquid-liquid separation system of FIG. 1A, according to certain embodiments.

FIG. 2 illustrates a flow chart of a method for separating a liquid-liquid mixture having an aqueous phase and an organic phase, according to certain embodiments.

FIG. 3 illustrates a scheme of reactions involved in preparation of modified alumina, according to certain embodiments.

FIG. 4 illustrates a scheme of reactions involved in preparation of nanocomposite of polypropylene and alumina, according to certain embodiments.

FIG. 5 illustrates a scheme of reactions involved in preparation of (Crown-6)-2,3,11,12-tetracarboxylic acid-modified graphene, according to certain embodiments.

FIG. 6 illustrates a graph depicting separation efficiency (%) of the system of FIG. 1A, according to certain embodiments.

### DETAILED DESCRIPTION

In the drawings, like reference numerals designate identical or corresponding parts throughout the several views. Further, as used herein, the words “a”, “an” and the like generally carry a meaning of “one or more”, unless stated otherwise.

Furthermore, the terms “approximately,” “approximate”, “about” and similar terms generally refer to ranges that include the identified value within a margin of 20%, 10%, or preferably 5%, and any values therebetween.

Aspects of the present disclosure are directed to a system for liquid-liquid separation and a method of liquid-liquid separation including an aqueous phase and an organic phase. The system disclosed herein aims to provide highly efficient and ecologically beneficial solutions for oil-water separation. Further, the system disclosed herein showed proficient operational aspects with regards to varied pollutants such as, but not limited to, toluene, cyclohexane, n-hexane, dichloromethane, and waste oil. The system may be retro-fitted to a plurality of oil pipelines and oil transportation arrangements to ensure ease-of-use and provide consistently uniform oil without any liquid phase impurities.

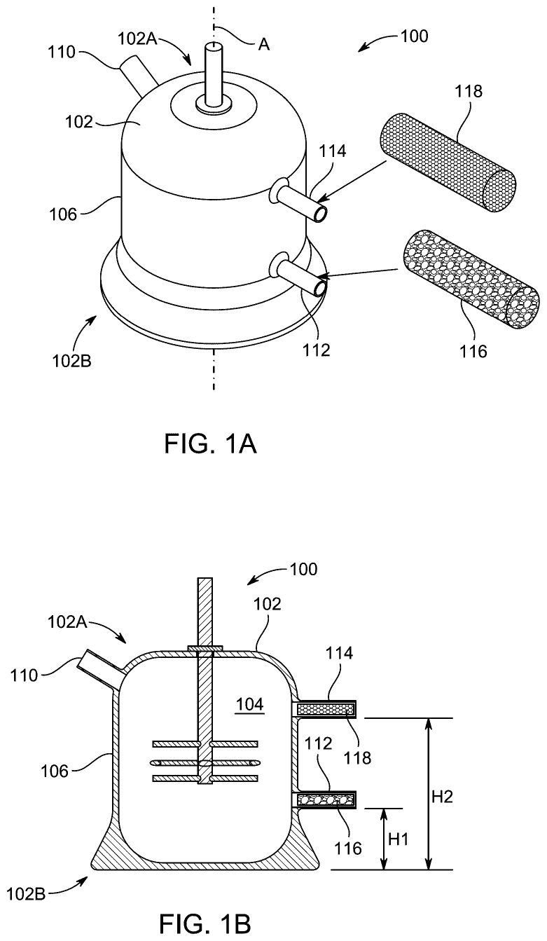

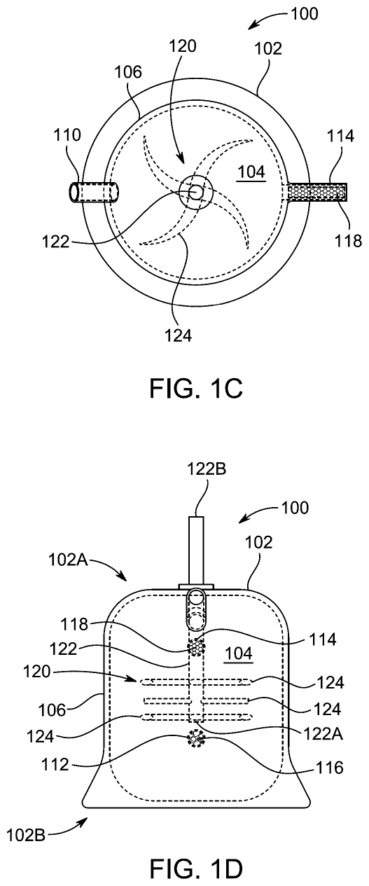

Referring to FIG. 1A, a schematic perspective view of an exemplary liquid-liquid separation system 100 is illustrated, according to an embodiment of the present disclosure. The liquid-liquid separation system 100 is alternatively referred to as ‘the system 100’ for the sake of brevity herein. The system 100 includes a mixing chamber 102 configured to receive a liquid-liquid mixture therein. The liquid-liquid mixture is alternatively referred to as ‘the mixture stream’ herein for convenience. In some embodiments, the mixture stream includes water and an organic chemical that is not miscible with the water. In some embodiments, the mixture stream may include a waste water, an oil- or petroleum-contaminated water, an industrial water, or a water contaminated with an organic chemical. In general, water can be may be any water containing solution, including saltwater, hard water, and/or fresh water. The term “saltwater” includes saltwater with a chloride ion content of between about 6,000 ppm and saturation, and is intended to encompass seawater and other types of saltwater including groundwater comprising additional impurities typically found therein. The term “hard water” includes water having mineral concentrations between about 2000 mg/L and about 300,000 mg/L. The term “fresh water” includes water sources that comprise less than 6000 ppm, preferably less than 5000 ppm, preferably less than 4000 ppm, preferably less than 3000 ppm, preferably less than 2000 ppm, preferably less than 1000 ppm, preferably less than 500 ppm of salts, minerals, or any other dissolved solids. Exemplary salts that may be present in saltwater, hard water, and/or fresh water include, but are not limited to, cations such as sodium, magnesium, calcium, potassium, ammonium, and iron, and anions such as chloride, bicarbonate, carbonate, sulfate, sulfite, phosphate, iodide, nitrate, acetate, citrate, fluoride, and nitrite. In some embodiments, the water used herein may be supplied or derived from a natural source, such as an aquifer, a lake, and/or an ocean. For example, the mixture stream can include a water from a natural source that has become contaminated as a result of a human activity such as an accidental chemical spill, an oil spill or leak, pollution or purposeful chemical disposal. In some embodiments, the mixture stream can include water from an industrial or artificial source. For example, the water can be provided directly from an industrial process or plant that results in the water being contaminated with an organic compound, such as petroleum drilling or exploitation, chemical synthesis, or manufacturing. In some embodiments, the mixture stream is filtered to remove large solids before being used in the system.

In an embodiment, the mixing chamber 102 may be a cylindrical structure having an internal volume 104, as shown in FIG. 1B, defined by a wall 106 to store the mixture stream. The mixing chamber 102 may have a height defined between a top end 102A and a bottom end 102B thereof. Dimensional specification and constructional features of the mixing chamber 102 may vary based on various details of an application thereof. That is, the exact dimensions may be adjusted to fit a specific use of the system.

In some embodiments, the mixing chamber 102 includes a mixture inlet 110 defined in the wall 106 near the top end 102A thereof. The mixture inlet 110 is configured to receive the mixture stream therethrough to receive the mixture stream within the internal volume 104 of the mixing chamber 102. In an embodiment, the mixture inlet 110 may be in the form of a conduit attached to the wall 106 of the mixing chamber 102 in such a way that the conduit is positioned at an angle relative to a central axis ‘A’ of the mixing chamber 102. In some embodiments, the mixture inlet 110 may be configured to fluidly communicate with a reservoir (not shown) via a pipe or a hose. In some embodiments, the reservoir may store the liquid-liquid mixture that is to be treated/separated, and the liquid-liquid mixture may be supplied to the mixture inlet 110 of the mixing chamber 102 through the pipe or the hose. In some embodiments, the liquid-liquid mixture may be supplied to the mixing chamber 102 through gravity. In some embodiments, the liquid-liquid mixture may be supplied from the reservoir to the mixing chamber 102 with the help of a pump.

In some embodiments, the mixing chamber 102 further includes an aqueous phase outlet 112 and an organic phase outlet 114 defined in the wall 106. In some embodiments, the aqueous and organic phase outlets 112, 114 are each disposed in the mixing chamber 102 diametrically opposite to the mixture inlet 110. In some embodiments, the aqueous phase outlet 112 and the organic phase outlet 114 can be defined in the wall 106 near the bottom end 102B and the top end 102A, respectively, of the mixing chamber 102. In some embodiments, the aqueous phase outlet 112 and the organic phase outlet 114 are configured to permit the water and the organic chemical of the mixture stream to exit therethrough, respectively. That is the water can exit via the aqueous phase outlet and the organic chemical can exit via the organic phase outlet. In an embodiment, the aqueous phase outlet 112 and the organic phase outlet 114 may be further fluidly communicated with a water reservoir (not shown) and an organic chemical reservoir (not shown), respectively, via separate pipes or hoses. Separation of the mixture stream into the water and the organic chemical is described below.

In some embodiments, the system 100 further includes a hydrophilic separator 116 connected to the aqueous phase outlet 112 and a hydrophobic separator 118 connected to the organic phase outlet 114. The hydrophilic separator 116 and the hydrophobic separator 118 are shown detached from the mixing chamber 102 in FIG. 1A for the illustration purpose of the present disclosure, which otherwise be disposed inside the aqueous phase outlet 112 and the organic phase outlet 114, as shown in FIG. 1B. In some embodiments, the hydrophilic separator 116 is configured to allow water to pass therethrough while preventing the organic chemical that is not miscible with the water from passing through the hydrophilic separator 116. In some embodiments, the hydrophobic separator 118 is configured to allow the organic chemical that is not miscible with the water to pass therethrough while preventing the water from passing through the hydrophobic separator 118.

Referring to FIG. 1B, a schematic sectional view of the system 100 is illustrated, according to an exemplary embodiment of the present disclosure. In particular, the wall 106 of the mixing chamber 102 is depicted cut along a plane defined parallel to the central axis ‘A’ to illustrate internal components of the mixing chamber 102. In some embodiments, the aqueous phase outlet 112 is defined in the form of a conduit having a first length. In one embodiment, the aqueous phase outlet 112 may be defined as an integral component of the mixing chamber 102 during the manufacturing of the mixing chamber 102. In an embodiment, the aqueous phase outlet 112 may be detachably attached to the wall 106 of the mixing chamber 102 using fastening members. In some embodiments, the aqueous phase outlet 112 may be attached to the mixing chamber 102 in such a way that the aqueous phase outlet 112 is positioned perpendicular to the central axis ‘A’ of the mixing chamber 102. In some embodiments, the hydrophilic separator 116 may be constructed in the form of a cylindrical shape configured to fit within the aqueous phase outlet 112. In some embodiments, the hydrophilic separator 116 may have a length equal to or smaller than the first length of the aqueous phase outlet 112. In some embodiments, a diameter of the hydrophilic separator 116 may be defined in such a way to firmly dispose the hydrophilic separator 116 within the aqueous phase outlet 112 using an interference fit or a press fit.

In some embodiments, the hydrophilic separator 116 is made of a crown-ether-modified carbon nanomaterial which includes a carbon nanomaterial, and a crown-ether disposed on a surface of the carbon nanomaterial. In some embodiments, the aqueous phase outlet 112 may be packed with the synthesized hydrophilic materials such as the crown-ether-modified carbon nanomaterial. In some embodiments, the crown-ether-modified carbon nanomaterial is hydrophilic and helps to separate only water while rejecting any small droplets of the organic chemical such as oil flowing with the water. The synthesized hydrophilic material may be particularly useful to maximize separation efficiency of the system 100.

In some embodiments, the organic phase outlet 114 is defined in the form of a conduit having a second length equal to the first length of the aqueous phase outlet 112. In some embodiments, the organic phase outlet 114 may be defined as an integral component of the mixing chamber 102 during the manufacturing of the mixing chamber 102. In an embodiment, the organic phase outlet 114 may be detachably attached to the wall 106 of the mixing chamber 102 using fastening members. In some embodiments, the organic phase outlet 114 is attached to the mixing chamber 102 in such a way that the organic phase outlet 114 is positioned perpendicular to the central axis ‘A’ of the mixing chamber 102. In an embodiment, the hydrophobic separator 118 may be constructed in the form of a cylindrical shape configured to fit within the organic phase outlet 114. In some embodiments, the hydrophobic separator 118 may have a length equal to or smaller than the second length of the organic phase outlet 114. In some embodiments, a diameter of the hydrophobic separator 118 may be defined in such a way to firmly dispose the hydrophobic separator 118 within the organic phase outlet 114 using an interference fit or a press fit.

In some embodiments, the hydrophobic separator 118 is made of a composite which includes a hydrophobic polymer and fatty acid-modified metal oxide nanoparticles. In some embodiments, the fatty acid-modified metal oxide nanoparticles include metal oxide nanoparticles having a fatty acid disposed on a surface of the metal oxide nanoparticles In some embodiments, the organic phase outlet 114 is packed with the synthesized hydrophobic materials such as the fatty acid-modified metal oxide nanoparticles. In some embodiments, the synthesized fatty acid-modified metal oxide nanoparticles are hydrophobic and are useful in assisting the rejection of water while separating only the organic chemical such as the oil.

In some embodiments, the organic phase (e.g., an oil) is not devoid of water. In some embodiments, smaller droplets of water may not settle by gravity and may remain in the organic phase. In some embodiments, the water-contaminated organic phase is further routed to a coalescer in order to reduce the water content even further. In some embodiments, the coalescer may be a vessel or process phase which causes small drops of a liquid to come together and form a stream or form elements with a larger volume. The synthesized hydrophobic material may be particularly useful to facilitate the separation and/or transfer of the organic phase.

In an embodiment, the aqueous phase outlet 112 and the organic phase outlet 114 are arranged in the mixing chamber 102 in such a way that the aqueous phase outlet 112 is oriented at an aqueous outlet height ‘H1’ lower than an organic outlet height ‘H2’ at which the organic phase outlet 114 is disposed. That is, the aqueous outlet height ‘H1’ defined between the bottom end 102B of the mixing chamber 102 and the aqueous phase outlet 112 is smaller than the organic outlet height ‘H2’ defined between the bottom end 102B of the mixing chamber 102 and the organic phase outlet 114.

Referring to FIG. 1C and FIG. 1D, a schematic top view and a schematic side view, respectively, of an exemplary system 100 is illustrated, according to certain embodiments of the present disclosure. In some embodiments, the system 100 includes a mixer 120 received within the internal volume 104 of the mixing chamber 102. In some embodiments, the mixer 120 includes a shaft 122 rotatably supported with the mixing chamber 102 and a plurality of blades 124 attached to the shaft 122. In some embodiments, the shaft 122 includes a first end 122A configured to pass through the top end 102A of the mixing chamber 102 into the internal volume 104 thereof and have the plurality of blades 124 attached to the shaft. In some embodiments, the shaft 122 further includes a second end 122B disposed outside the mixing chamber 102 and configured to receive a rotary power from an external device (not shown). In some embodiments, the external device may be a motor configured to engage with the second end 122B of the shaft 122 such that a rotary output power of the motor may be used to rotate the shaft 122, which in turn may rotate the plurality of blades 124. In some embodiments, the motor may be in communication with a controller such that the rotary output power of the motor may be controlled based on various input parameters including, but not limited to, the type of liquid-liquid mixture, the type of organic chemical, the type of water, a feed temperature, and feed pressure of the liquid-liquid mixture.

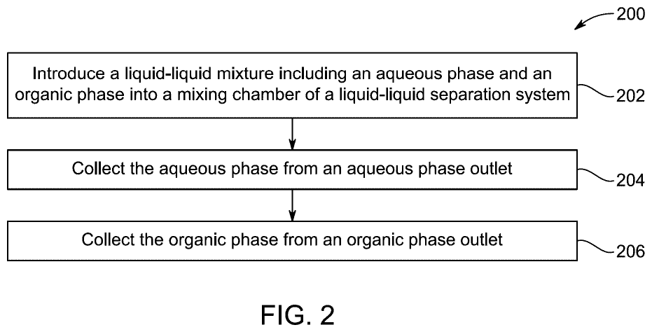

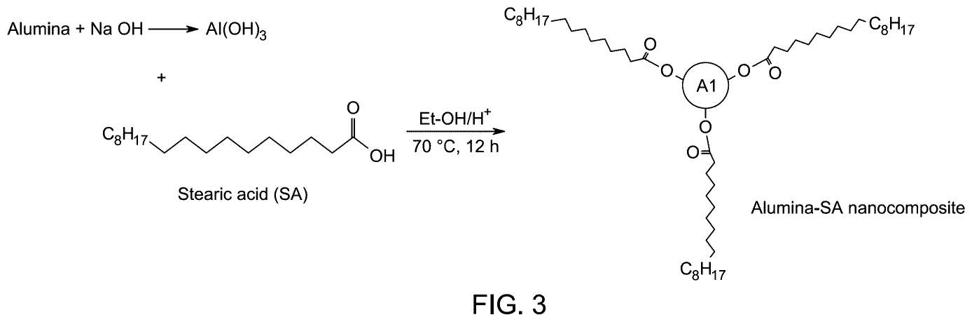

Referring to FIG. 2, a schematic flow diagram of an exemplary method 200 of separating the liquid-liquid mixture including an aqueous phase and an organic phase is illustrated, according to an embodiment of the present disclosure. The order in which the method 200 is described is not intended to be construed as a limitation, and any number of the described method steps can be combined in any order to implement the method 200. Additionally, individual steps may be removed or skipped from the method 200 without departing from the spirit and scope of the present disclosure.

At step 202, the method 200 includes introducing the liquid-liquid mixture into the mixing chamber 102 of the system 100. In some embodiments, the liquid-liquid mixture is introduced into the system 100 via the mixture inlet 110. As described above, in some embodiments, the mixture inlet 110 may be conduit where the conduit is further communicated with the pipe or the hose having the pump in order to provide necessary pressure for the system 100 to work efficiently. In some embodiments, a gravity feed may be employed for the system 100 to perform the described functions. In some embodiments, the liquid-liquid mixture introduced in the mixing chamber 102 undergoes separation by the hydrophilic separator 116 and the hydrophobic separator 118.

In some embodiments, the hydrophilic separator 116 includes the crown-ether-modified carbon nanomaterial. In some embodiments, the crown-ether-modified carbon nanomaterial is prepared by treating a carbon nanomaterial with an acid and a hydrogen peroxide to form an oxidized carbon nanomaterial. In general, the carbon nanomaterial may be any suitable carbon nanomaterial known to one of ordinary skill in the art. Examples of carbon nanomaterials include carbon nanotubes, carbon nanobuds, carbon nanoscrolls, carbon dots, activated carbon, carbon black, graphene, graphene oxide, reduced graphene oxide, and nanodiamonds. In some embodiments, the carbon nanomaterial is at least one selected from the group consisting of graphene, graphene oxide, reduced graphene oxide, carbon nanotubes, carbon dots, and activated carbon.

In some embodiments, the carbon nanomaterial is carbon nanotubes. The carbon nanotubes may, in general, be any suitable carbon nanotubes known to one of ordinary skill in the art. Carbon nanotubes may be classified by structural properties such as the number of walls or the geometric configuration of the atoms that make up the nanotube. Classified by their number of walls, the carbon nanotubes can be single-walled carbon nanotubes (SWCNT) which have only one layer of carbon atoms arranged into a tube, or multi-walled carbon nanotubes (MWCNT), which have more than one single-layer tube of carbon atoms arranged so as to be nested, one tube inside another, each tube sharing a common orientation. Closely related to MWNTs are carbon nanoscrolls. Carbon nanoscrolls are structures similar in shape to a MWCNT, but made of a single layer of carbon atoms that has been rolled onto itself to form a multi-layered tube with a free outer edge on the exterior of the nanoscroll and a free inner edge on the interior of the scroll and open ends. The end-on view of a carbon nanoscroll has a spiral-like shape. For the purposes of this disclosure, carbon nanoscrolls are considered a type of MWCNT. Classified by the geometric configuration of the atoms that make up the nanotube, carbon nanotubes can be described by a pair of integer indices n and m. The indices n and m denote the number of unit vectors along two directions in the honeycomb crystal lattice of a single layer of carbon atoms. If m=0, the nanotubes are called zigzag type nanotubes. If n=m, the nanotubes are called armchair type nanotubes. Otherwise, they are called chiral type nanotubes. In some embodiments, the carbon nanotubes are metallic. In other embodiments, the carbon nanotubes are semiconducting. In some embodiments, the carbon nanotubes are SWCNTs. In other embodiments, the carbon nanotubes are MWCNTs. In some embodiments, the carbon nanotubes are carbon nanoscrolls. In some embodiments, the carbon nanotubes are zigzag type nanotubes. In alternative embodiments, the carbon nanotubes are armchair type nanotubes. In other embodiments, the carbon nanotubes are chiral type nanotubes.

In some embodiments, the carbon nanomaterial is graphene. In some embodiments, the carbon nanomaterial is graphene nanosheets. Graphene nanosheets may consist of stacks of graphene sheets, the stacks having an average thickness and a diameter. In some embodiments, the stacks comprise 1 to 60 sheets of graphene, preferably 2 to 55 sheets of graphene, preferably 3 to 50 sheets of graphene.

In some embodiments, the graphene is in the form of graphene particles. The graphene particles may have a spherical shape, or may be shaped like blocks, flakes, ribbons, discs, granules, platelets, angular chunks, rectangular prisms, or some other shape. In some embodiments, the graphene particles may be substantially spherical, meaning that the distance from the graphene particle centroid (center of mass) to anywhere on the graphene outer surface varies by less than 30%, preferably by less than 20%, more preferably by less than 10% of the average distance. In some embodiments, the graphene particles may be in the form of agglomerates.

In some embodiments, the graphene is pristine graphene. Pristine graphene refers to graphene that has not been oxidized or otherwise functionalized. Pristine graphene may be obtained by methods such as exfoliation, chemical vapor deposition synthesis, opening of carbon nanotubes, unrolling of carbon nanoscrolls, and the like. In alternative embodiments, the graphene is functionalized graphene. Functionalized graphene is distinguished from pristine graphene by the presence of functional groups on the surface or edge of the graphene that contain elements other than carbon and hydrogen. In other alternative embodiments, the graphene is graphene oxide. Graphene oxide refers to graphene that has various oxygen-containing functionalities that are not present in pristine graphene. Examples of such oxygen-containing functionalities include epoxides, carbonyl, carboxyl, and hydroxyl functional groups. Graphene oxide is sometimes considered to be a type of functionalized graphene.

In other alternative embodiments, the graphene is reduced graphene oxide. Reduced graphene oxide (rGO) refers to graphene oxide that has been chemically reduced. It is distinct from graphene oxide in it contains substantially fewer oxygen-containing functionalities compared to graphene oxide, and it is distinct from pristine graphene by the presence of oxygen-containing functionalities and structural defects in the carbon network. Reduced graphene oxide is sometimes considered to be a type of functionalized graphene. In preferred embodiments, the carbon nanomaterial is reduced graphene oxide. The reduced graphene oxide may exist as nanosheets, particles having a spherical shape, or may be shaped like blocks, flakes, ribbons, discs, granules, platelets, angular chunks, rectangular prisms, or some other shape as described above, agglomerates as described above, or any other shape known to one of ordinary skill in the art.

In some embodiments, the carbon nanoparticles are activated carbon. Activated carbon refers to a form of porous carbon having a semi-crystalline, semi-graphitic structure and a large surface area. Activated carbon may be in the form of particles or particulate aggregates having micropores and/or mesopores. Activated carbon typically has a surface area of approximately 500 to 5000 m²/g. The activated carbon particles may have a spherical shape, or may be shaped like sheets, blocks, flakes, ribbons, discs, granules, platelets, angular chunks, rectangular prisms, or some other shape. In some embodiments, the activated carbon particles may be substantially spherical, meaning that the distance from the activated carbon particle centroid (center of mass) to anywhere on the activated carbon particle outer surface varies by less than 30%, preferably by less than 20%, more preferably by less than 10% of the average distance.

In some embodiments, the carbon nanoparticles are carbon black. Carbon black refers to having a semi-crystalline, semi-graphitic structure and a large surface area. Carbon black may be distinguished from activated carbon by a comparatively lower surface area, typically 15 to 500 m²/g for carbon black. Additionally, carbon black may lack the requisite micropores and mesopores of activated carbon. The carbon black particles may have a spherical shape, or may be shaped like sheets, blocks, flakes, ribbons, discs, granules, platelets, angular chunks, rectangular prisms, or some other shape.

In some embodiments, the particles of a carbon nanomaterial are a single type of particle as described above. In this context, “a single type of particle” may refer to particles of a single carbon nanomaterial, particles which have substantially the same shape, particles which have substantially the same size, or any combination of these. In alternative embodiments, mixtures of types of particles are used.

In some embodiments, the carbon nanomaterial is present in the form of sheets having a mean thickness of 50 to 500 nm, preferably 60 to 475 nm, preferably 75 to 450 nm, preferably 100 to 425 nm, preferably 110 to 400 nm, preferably 125 to 375 nm, preferably 150 to 350 nm and a mean width of 500 to 5000 nm, preferably 550 to 4750 nm, preferably 600 to 4500 nm, preferably 650 to 4250 nm, preferably 700 to 4000 nm, preferably 750 to 3900 nm, preferably 800 to 3800 nm, preferably 850 to 3700 nm, preferably 900 to 3600 nm, preferably 950 to 3500 nm, preferably 1000 to 3400 nm.

In some embodiments, the sheets have a monodisperse thickness, having a coefficient of variation or relative standard deviation, expressed as a percentage and defined as the ratio of the sheet thickness standard deviation (o) to the sheet thickness mean (u), multiplied by 100%, of less than 25%, preferably less than 10%, preferably less than 8%, preferably less than 6%, preferably less than 5%. In a preferred embodiment, the sheets have a monodisperse thickness, having a size distribution ranging from 80% of the average thickness to 120% of the average thickness, preferably 85 to 115%, preferably 90 to 110% of the average thickness. In another embodiment, the sheets do not have a monodisperse thickness. In some embodiments, the sheets have a monodisperse diameter, having a coefficient of variation or relative standard deviation, expressed as a percentage and defined as the ratio of the sheet diameter standard deviation (o) to the sheet diameter mean (u), multiplied by 100%, of less than 25%, preferably less than 10%, preferably less than 8%, preferably less than 6%, preferably less than 5%. In a preferred embodiment, the sheets have a monodisperse diameter, having a size distribution ranging from 80% of the average diameter to 120% of the average diameter, preferably 85 to 115%, preferably 90 to 110% of the average diameter. In another embodiment, the sheets do not have a monodisperse diameter.

In general, the carbon nanomaterial can be any shape known to one of ordinary skill in the art. Examples of suitable shapes the carbon nanomaterial may take include spheres, spheroids, lentoids, ovoids, solid polyhedra such as tetrahedra, cubes, octahedra, icosahedra, dodecahedra, hollow polyhedra (also known as nanocages), stellated polyhedra (both regular and irregular, also known as nanostars), triangular prisms (also known as nanotriangles), hollow spherical shells (also known as nanoshells), tubes (also known as nanotubes), nanosheets, nanoplatelets, nanodisks, rods (also known as nanorods), and mixtures thereof. In the case of nanorods, the rod shape may be defined by a ratio of a rod length to a rod width, the ratio being known as the aspect ratio. For carbon nanomaterial of the current invention, nanorods should have an aspect ratio less than 1000, preferably less than 750, preferably less than 500, preferably less than 250, preferably less than 100, preferably less than 75, preferably less than 50, preferably less than 25.

In some embodiments, the carbon nanomaterial has uniform shape. Alternatively, the shape may be non-uniform. As used herein, the term “uniform shape” refers to an average consistent shape that differs by no more than 10%, by no more than 5%, by no more than 4%, by no more than 3%, by no more than 2%, by no more than 1% of the distribution of the carbon nanomaterial having a different shape. As used herein, the term “non-uniform shape” refers to an average consistent shape that differs by more than 10% of the distribution of the carbon nanomaterial having a different shape. In one embodiment, the shape is uniform and at least 90% of the carbon nanomaterial are spherical or substantially circular, and less than 10% are polygonal. In another embodiment, the shape is non-uniform and less than 90% of the carbon nanomaterial are spherical or substantially circular, and greater than 10% are polygonal.

In some embodiments, the carbon nanomaterial has a mean particle size of 5 to 100 nm, preferably 7.5 to 75 nm, preferably 10 to 60 nm, preferably 12.5 to 50 nm, preferably 15 to 40 nm, preferably 15.5 to 35 nm, preferably about 16 to 32 nm. In embodiments where the carbon nanomaterial is spherical, the particle size may refer to a particle diameter. In embodiments where the carbon nanomaterial is polyhedral, the particle size may refer to the diameter of a circumsphere. In some embodiments, the particle size refers to a mean distance from a particle surface to particle centroid or center of mass. In alternative embodiments, the particle size refers to a maximum distance from a particle surface to a particle centroid or center of mass. In some embodiments where the carbon nanomaterial has an anisotropic shape such as nanorods, the particle size may refer to a length of the nanorod, a width of the nanorod, an average of the length and width of the nanorod. In some embodiments in which the carbon nanomaterial has non-spherical shapes, the particle size refers to the diameter of a sphere having an equivalent volume as the particle. In some embodiments in which the carbon nanomaterial has non-spherical shapes, the particle size refers to the diameter of a sphere having an equivalent diffusion coefficient as the particle.

In some embodiments, the carbon nanomaterial of the present disclosure are monodisperse, having a coefficient of variation or relative standard deviation, expressed as a percentage and defined as the ratio of the particle size standard deviation (o) to the particle size mean (u) multiplied by 100 of less than 25%, preferably less than 10%, preferably less than 8%, preferably less than 6%, preferably less than 5%, preferably less than 4%, preferably less than 3%, preferably less than 2%. In some embodiments, the carbon nanomaterial of the present disclosure is monodisperse having a particle size distribution ranging from 80% of the average particle size to 120% of the average particle size, preferably 90-110%, preferably 95-105% of the average particle size. In some embodiments, the carbon nanomaterial is not monodisperse.

In general, the particle size may be determined by any suitable method known to one of ordinary skill in the art. In some embodiments, the particle size is determined by powder X-ray diffraction (PXRD). Using PXRD, the particle size may be determined using the Scherrer equation, which relates the full-width at half-maximum (FWHM) of diffraction peaks to the size of regions comprised of a single crystalline domain (known as crystallites) in the sample. In some embodiments, the crystallite size is the same as the particle size. For accurate particle size measurement by PXRD, the particles should be crystalline, comprise only a single crystal, and lack non-crystalline portions. Typically, the crystallite size underestimates particle size compared to other measures due to factors such as amorphous regions of particles, the inclusion of non-crystalline material on the surface of particles such as bulky surface ligands, and particles which may be composed of multiple crystalline domains. In some embodiments, the particle size is determined by dynamic light scattering (DLS). DLS is a technique which uses the time-dependent fluctuations in light scattered by particles in suspension or solution in a solvent, typically water to measure a size distribution of the particles. Due to the details of the DLS setup, the technique measures a hydrodynamic diameter of the particles, which is the diameter of a sphere with an equivalent diffusion coefficient as the particles. The hydrodynamic diameter may include factors not accounted for by other methods such as non-crystalline material on the surface of particles such as bulky surface ligands, amorphous regions of particles, and surface ligand-solvent interactions. Further, the hydrodynamic diameter may not accurately account for non-spherical particle shapes. DLS does have an advantage of being able to account for or more accurately model solution or suspension behavior of the particles compared to other techniques. In some embodiments, the particle size is determined by electron microscopy techniques such as scanning electron microscopy (SEM) or transmission electron microscopy (TEM).

In general, the acid may be organic or inorganic. In some embodiments, the acid is inorganic. Suitable examples of inorganic acids include, but are not limited to, hydrochloric acid, nitric acid phosphoric acid, sulfuric acid, boric acid, hydrofluoric acid, hydrobromic acid, perchloric acid, hydroiodic acid, and/or combinations thereof. In some embodiments, the acid is a mixture of phosphoric acid and sulfuric acid. In some embodiments, he mixture of phosphoric acid and sulfuric acid has a molar ratio of phosphoric acid to sulfuric acid of 0.01:1 to 0.25:1.

In some embodiments, the reaction between the carbon nanomaterial and the acid is carried out in the presence of an oxidizing agent, preferably a strong oxidizing agent. Suitable examples of the oxidizing agent include, but are not limited to, oxygen, ozone, hydrogen peroxide (H₂O₂) and other inorganic peroxides, Fenton's reagent, halogens, hypochlorite, chlorite, chlorate, perchlorate, and other analogous halogen oxyanions, fluorides of chlorine, bromine, and iodine, hexavalent chromium compounds such as chromic and dichromic acids and chromium trioxide, pyridinium chlorochromate (PCC), and chromate/dichromate compounds such as Sodium dichromate (Na₂Cr₂O₇), permanganate compounds such as potassium permanganate (KMnO₄), nitrous oxide (N₂O), nitrogen dioxide/dinitrogen tetroxide, sodium bismuthate (NaBiO₃), cerium (IV) compounds such as ceric ammonium nitrate and ceric sulfate. In some embodiments, the oxidizing agent is KMnO₄. In some embodiments, the oxidizing agent is H₂O₂. In some embodiments, the oxidizing agent is a mixture of KMnO₄ and H₂O₂.

Typically, the oxidizing agent is added to oxidize the carbon nanomaterial. In some embodiments, the weight ratio of the carbon nanomaterial to the oxidizing agent is in the range of 1:3 to 1:4. In some embodiments, hydrogen peroxide is added to act as a quencher to stop the oxidation reaction. In some embodiments, the reaction is carried out at a temperature of 30 to 60° C., preferably 35 to 55° C., preferably 40 to 52.5° C., preferably at about 50° C. for about 8 to 15 hours, preferably 10 to 13 hours, preferably about 12 hours to form a crude oxidized carbon nanomaterial. In some embodiments, the crude produce is washed with water/acid, such as aqueous HCl, to remove unreacted metal ions and impurities to form the oxidized carbon nanomaterial. In some embodiments, the oxidized carbon nanomaterial is graphene oxide. Although the description herein provided is based on Hummer's method for the preparation of graphene oxide, it may be understood by a person skilled in the art, that other methods known conventionally may be adopted as well, as may be obvious to a person skilled in the art.

In some embodiments, the oxidized carbon nanomaterial is further reacted with a crown ether carboxylic acid. In some embodiments, the oxidized carbon nanomaterial is reacted with the crown ether in a weight ratio of 1:1 to 2.5:1, preferably 1.25:1 to 2.25:1, preferably 1.4:1 to 2.0:1, preferably 1.5:1 to 1.8:1, preferably about 1.6:1 to 1.7:1.

In general, a functional group present in the crown ether carboxylic acid can react with a suitable functional group present in the graphene oxide. For example, the carboxylic acid of the crown ether carboxylic acid can react with a suitable functional group present in the graphene oxide, such as a hydroxyl group, an amine, a carboxylic acid, or a combination of these. Such a reaction can produce a linkage group that links the crown ether carboxylic acid and the graphene oxide. Examples of linkage groups include, but are not limited to esters, amides, anhydrides, ethers, ketones, and the like. The crown ether is preferably covalently bonded to the graphene oxide.

In some embodiments, this reaction is carried out in the presence of a catalyst. Such a catalyst may catalyze a specific reaction between the functional group present in the crown ether carboxylic acid and the functional group present in the graphene oxide. For example, the catalyst can catalyze a reaction between the carboxylic acid of the crown ether carboxylic acid can react with a suitable functional group present in the graphene oxide, such as a hydroxyl group, an amine, a carboxylic acid, or a combination of these. Such a reaction can produce a linkage group that is an ester, amide, anhydride, or combinations of these. In some embodiments, the catalyst is a carbodiimide catalyst. In some embodiments, the carbodiimide catalyst is dicyclohexylcarbodiimide (DCC).

In some embodiments, this reaction is carried out at a temperature of 110 to 160° C., preferably 120 to 150° C., more preferably at about 130° C. for about 15 to 30 hours, preferably 16 to 28 hours, preferably 18 to 26 hours, preferably 20 to 25 hours, preferably about 24 hours, under stirring, to form a crude crown-ether-modified carbon nanomaterial. In some embodiments, the crude crown-ether-modified carbon nanomaterial is further filtered (for example, via centrifugation) and then dried to form the crown-ether-modified carbon nanomaterial. In some embodiments, the crown ether carboxylic acid is (18-Crown-6)-2,3,11,12-tetracarboxylic acid. In some embodiments, the crown-ether-modified carbon nanomaterial is further disposed in the hydrophilic separator 116 and helps separate the aqueous component during the liquid-liquid separation.

In some embodiments, the liquid-liquid separation system also includes a hydrophobic separator 118. In some embodiments, the hydrophobic separator 118 includes a composite of fatty acid-modified metal oxide nanoparticles and a hydrophobic polymer. In some embodiments, the composite is formed by heating a mixture of metal hydroxide and a fatty acid to form fatty acid-modified metal oxide nanoparticles. In general, the metal hydroxide may be procured commercially or prepared via reacting metal oxide nanoparticles with a base, such as sodium hydroxide. In some embodiments, the metal hydroxide is aluminum hydroxide, and the metal oxide nanoparticles are alumina nanoparticles. In some embodiments, the alumina nanoparticles are preferably in the form of a powder.

In general, the fatty acid can be any suitable type of fatty acid. For example, the fatty acid can be a saturated fatty acid, a monounsaturated fatty acid, a polyunsaturated fatty acid, or a mixture of these. Examples of suitable fatty acids include, but are not limited to caprylic acid, xapric acid, lauric acid, myristic acid, palmitic acid, stearic acid, arachidic acid, behenic acid, lignoceric acid, cerotic acid, eicosapentaenoic acid, α-linolenic acid, docosahexaenoic acid, arachidonic acid, linoleic acid, linoelaidic acid, oleic acid, elaidic acid, erucic acid, myristoleic acid, palmitoleic acid, vaccenic acid, and sapienic acid. In some embodiments, the fatty acid is stearic acid.

In some embodiments, the metal hydroxide is heated with the fatty acid and ultrasonication for 1 to 5 hours, preferably 2 to 4 hours, preferably 3 hours. In some embodiments, the metal hydroxide is heated with the fatty acid at a temperature of 50 to 75° C., preferably 55 to 65° C., preferably 60° C. In some embodiments, the metal hydroxide and the fatty acid are stirred at a temperature of 60 to 80° C., preferably 65 to 75° C., preferably 70° C. for 5 to 15 hours, preferably 10 to 13 hours, preferably about 12 hours, to form the fatty acid-modified metal oxide nanoparticles.

In general, the fatty acid-modified metal oxide nanoparticles can be any shape known to one of ordinary skill in the art. Examples of suitable shapes the fatty acid-modified metal oxide nanoparticles may take include spheres, spheroids, lentoids, ovoids, solid polyhedra such as tetrahedra, cubes, octahedra, icosahedra, dodecahedra, hollow polyhedra (also known as nanocages), stellated polyhedra (both regular and irregular, also known as nanostars), triangular prisms (also known as nanotriangles), hollow spherical shells (also known as nanoshells), tubes (also known as nanotubes), nanosheets, nanoplatelets, nanodisks, rods (also known as nanorods), and mixtures thereof. In the case of nanorods, the rod shape may be defined by a ratio of a rod length to a rod width, the ratio being known as the aspect ratio. For fatty acid-modified metal oxide nanoparticles of the current invention, nanorods should have an aspect ratio less than 1000, preferably less than 750, preferably less than 500, preferably less than 250, preferably less than 100, preferably less than 75, preferably less than 50, preferably less than 25.

In some embodiments, the fatty acid-modified metal oxide nanoparticles have a uniform shape. Alternatively, the shape may be non-uniform. As used herein, the term “uniform shape” refers to an average consistent shape that differs by no more than 10%, by no more than 5%, by no more than 4%, by no more than 3%, by no more than 2%, by no more than 1% of the distribution of the fatty acid-modified metal oxide nanoparticles having a different shape. As used herein, the term “non-uniform shape” refers to an average consistent shape that differs by more than 10% of the distribution of the fatty acid-modified metal oxide nanoparticles having a different shape. In one embodiment, the shape is uniform and at least 90% of the fatty acid-modified metal oxide nanoparticles are spherical or substantially circular, and less than 10% are polygonal. In another embodiment, the shape is non-uniform and less than 90% of the fatty acid-modified metal oxide nanoparticles are spherical or substantially circular, and greater than 10% are polygonal.

In some embodiments, the fatty acid-modified metal oxide nanoparticles have a mean particle size of 5 to 100 nm, preferably 7.5 to 75 nm, preferably 10 to 60 nm, preferably 12.5 to 50 nm, preferably 15 to 40 nm, preferably 15.5 to 35 nm, preferably about 16 to 32 nm. In embodiments where the fatty acid-modified metal oxide nanoparticles are spherical, the particle size may refer to a particle diameter. In embodiments where the fatty acid-modified metal oxide nanoparticles are polyhedral, the particle size may refer to the diameter of a circumsphere. In some embodiments, the particle size refers to a mean distance from a particle surface to particle centroid or center of mass. In alternative embodiments, the particle size refers to a maximum distance from a particle surface to a particle centroid or center of mass. In some embodiments where the fatty acid-modified metal oxide nanoparticles have an anisotropic shape such as nanorods, the particle size may refer to a length of the nanorod, a width of the nanorod, an average of the length and width of the nanorod. In some embodiments in which the fatty acid-modified metal oxide nanoparticles have non-spherical shapes, the particle size refers to the diameter of a sphere having an equivalent volume as the particle. In some embodiments in which the fatty acid-modified metal oxide nanoparticles have non-spherical shapes, the particle size refers to the diameter of a sphere having an equivalent diffusion coefficient as the particle.

In some embodiments, the fatty acid-modified metal oxide nanoparticles of the present disclosure are monodisperse, having a coefficient of variation or relative standard deviation, expressed as a percentage and defined as the ratio of the particle size standard deviation (o) to the particle size mean (u) multiplied by 100 of less than 25%, preferably less than 10%, preferably less than 8%, preferably less than 6%, preferably less than 5%, preferably less than 4%, preferably less than 3%, preferably less than 2%. In some embodiments, the fatty acid-modified metal oxide nanoparticles of the present disclosure are monodisperse having a particle size distribution ranging from 80% of the average particle size to 120% of the average particle size, preferably 90-110%, preferably 95-105% of the average particle size. In some embodiments, the fatty acid-modified metal oxide nanoparticles are not monodisperse.

In some embodiments, the fatty acid-modified metal oxide nanoparticles are mixed with the hydrophobic polymer to form the composite. Examples of suitable hydrophobic polymers include, but are not limited to an acrylic polymer, an ether polymer, a fluorocarbon polymer, a polyolefin polymer, poly(vinyl chloride), polyvinylpyrrolidone (PVP), and any permissible combinations or copyolymers thereof. In some embodiments, the hydrophobic polymer is propylene. In some embodiments, the reaction between the fatty acid-modified metal oxide nanoparticles and the hydrophobic polymer is carried out in a solvent. In some embodiments, the solvent may be organic or aqueous or a mixture thereof. In some embodiments, the solvent is a mixture of alcohol and water. In general, the alcohol can be any suitable monool or polyol. Examples of suitable such alcohols include, but are not limited to methanol, ethanol, n-propanol, 2-propanol, n-butanol, 2-butanol, ethylene glycol, propylene glycol, diethylene glycol, and glycerol. In some embodiments, the alcohol is a mixture of ethanol and ethylene glycol. In some embodiments, the reaction is carried out for 1 to 5 hours, preferably 2 to 4 hours, preferably 3 hours. In some embodiments, the reaction is carried out at a temperature of 50 to 75° C., preferably 55 to 65° C., preferably 60° C. to form the composite. In some embodiments, the composite is further disposed in the hydrophobic separator 118. In some embodiments, the hydrophobic separator is useful to cause or assist removal of hydrophobic components, such as oils such as toluene, isooctane, hexane, olive oil, lubricating oil, and the like.

At step 204, the method 200 includes collecting the aqueous phase from the aqueous phase outlet 112. That is, after the separation of the liquid-liquid mixture, the aqueous phase outlet 112 is used to collect the aqueous phase contained in liquid-liquid mixture. In some embodiments, the aqueous phase may refer to water, or water-like impurities present in the liquid-liquid mixture, introduced in the mixing chamber 102 of the system 100. As described above, the aqueous phase outlet 112 includes the hydrophilic separator 116, used to filter out the water and water-like impurities out of the liquid-liquid mixture.

At step 206, the method 200 includes collecting the organic phase from the organic phase outlet 114. That is, after the separation of the liquid-liquid mixture, the organic phase outlet 114 is used to collect the organic phase contained in the liquid-liquid mixture. In some embodiments, the organic phase may refer to oil, or oil-like impurities present in the liquid-liquid mixture, introduced in the mixing chamber 102 of the system 100. As described above, the organic phase outlet 114 includes the hydrophobic separator 118, used to filter out the oil and oil-like impurities out of the liquid-liquid mixture.

### EXAMPLES

The following examples demonstrate the liquid-liquid separation system 100 and the method 200 of separating the liquid-liquid mixture including the aqueous phase and the organic phase according to certain embodiments of the present disclosure. The examples are provided solely for illustration and are not to be construed as limitations of the present disclosure, as many variations thereof are possible without departing from the spirit and scope of the present disclosure.

### Example 1: Materials

Potassium permanganate (KMnO₄), sulphuric acid (H₂SO₄), 96% weight by weight (w/w), phosphoric acid (H₃PO₄), 85% w/w, hydrogen peroxide (H₂O₂), 30%, urea, ammonium sulphate [(NH₄)₂SO₄] and ammonium phosphate [(NH₄)₃PO₄] were purchased from Sigma Aldrich. Further, graphite powder and lubricating oil were collected. 18-Crown-6)-2,3,11,12-tetracarboxylic acid, sodium hydroxide (NaOH), nitric acid (HNO₃), were purchased from Fluka and used as received. Potassium persulphate (K₂O₈S₂), nitrogen, toluene, n-Hexane, cyclohexane, dichliromethane, chloroform, and ethanol were purchased from Sigma Aldrich. Distilled water was obtained from in-house built distillation unit.

### Example 2: Preparation of Stearic Acid Modified Alumina

10 grams (g) of alumina Al₂O₃ powder was kept in a 500 milliliters (mL) round bottom flask, equipped with a condenser. About 100 mL NaOH 0.5 molar (M) was added and stirred at room temperature for 12 hours (h). Both of these solutions were dried at around 80 degrees Celsius (° C.) in order to allow the solvent to evaporate and obtain alumina hydroxide(s) as reaction products. 15 g stearic acid (SA) was gradually poured into the prepared alumina hydroxide(s) and the mixture was ultrasonicated for 3 h, at 60° C. in conjunction with magnetic stirring for 12 h at 70° C., to produce functionalized alumina-SA. The final product was dried and left overnight at 60° C. A schematic illustration of the above-described reaction is provided in FIG. 3.

### Example 3: Preparation of the Hydrophobic Nanocomposite

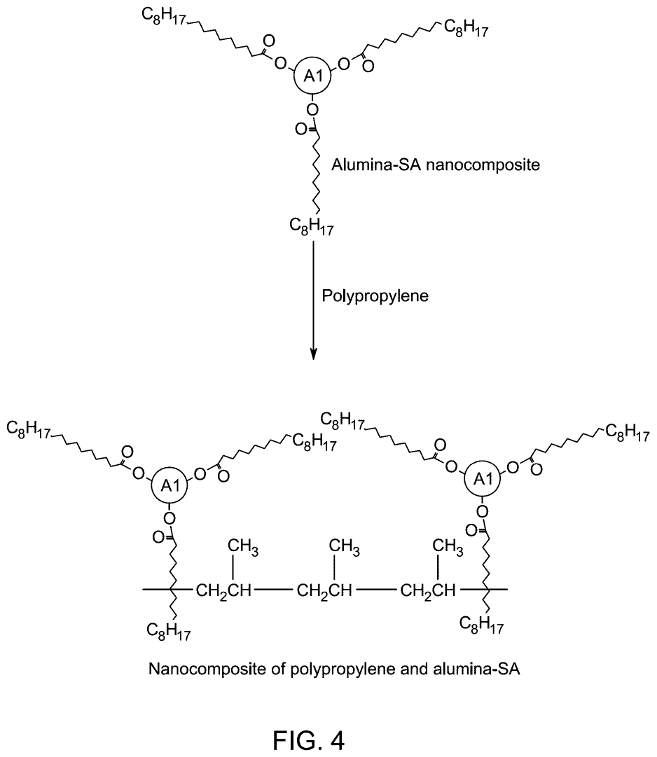

FIG. 4 is a schematic illustration of reactions involved in preparation of hydrophobic nanocomposite. In particular, distilled water was deoxygenated with a nitrogen atmosphere for a pre-determined amount of time. Polypropylene was added into the prepared and functionalized alumina-SA, the above mixture was stirred in the presence of 100 mL ethanol, 50 mL of ethylene glycol, and water. The reaction components were kept under sonication for 3 h. The reaction components were refluxed for 3 h at 60° C. The above-described mixture was cooled, separated, and dried. The water contact angle of the prepared hydrophobic nanocomposite was measured to be 158°, which indicates the high hydrophobicity of the prepared hydrophobic nanocomposite.

### Example 4: Synthesis of Graphene

The graphene was prepared from waste graphite. 700 mL of ice-cold H₂SO₄, 96% w/w and 80 mL of H₃PO₄ were combined with 7 g of graphite powder and 26 g of KMnO₄ while being stirred. The mixture was heated for 12 h at 50° C. while being stirred, and subsequently the mixture was placed in 600 mL deionized water with 15 mL H₂O₂, 30% w/w. The mixture was allowed to cool at room temperature for the next 24 h. Before the supernatant was taken out, the finished product was left to settle overnight. The product was repeatedly washed in water to remove any leftover acid. After three rounds of washing with 10% w/w HCl and distilled water to remove unreacted metal ions, the remaining material was finally dissolved in deionized water, where unreacted graphite precipitated, and the graphene oxide (GO) was dissolved. The dissolved GO was decanted, spun at 1000 revolutions per minute (rpm) for two hours, and then dried.

### Example 5: Synthesis of the Functionalized GO

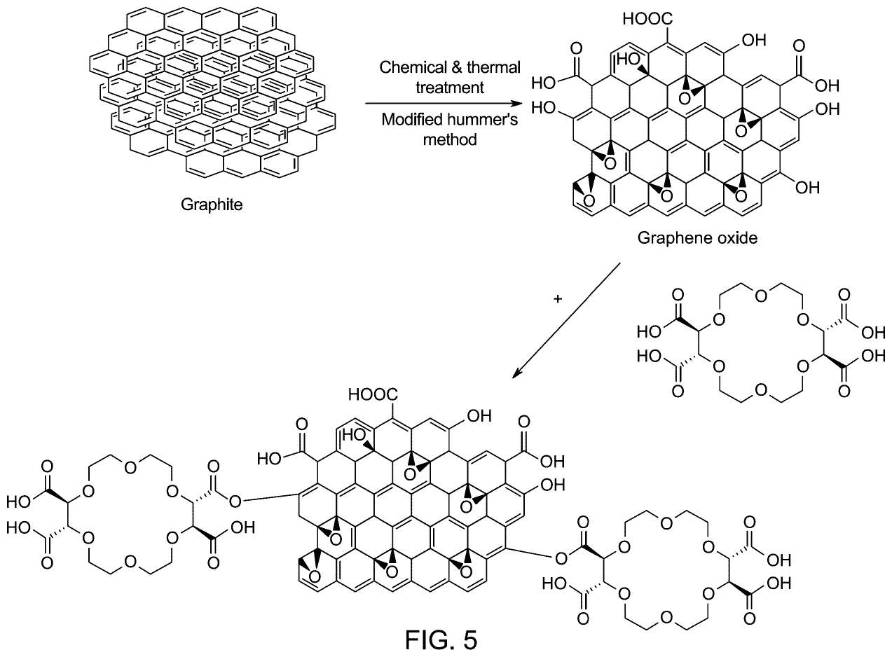

FIG. 5 is a schematic illustration of a reactions involved in preparation of graphene and GO. About 5 g GO was dispersed in 100 mL ethanol and 100 mL water. The above-described solution was ultrasonicated for 2 h. 3 g 18-Crown-6)-2,3,11,12-tetracarboxylic acid was added to the mixture and sonicated for 1 h. 0.1 g of N,N′-Dicyclohexylcarbodiimide (DCC or DCCD) catalyst was introduced, and the reaction mixture was sonicated for an additional hour. The resultant dispersion was maintained at 130° C., stirred, and kept under a nitrogen environment one day in order to allow the reaction to complete. The product was collected by centrifuging the reaction mixture at 1000 rpm for two hours. The resultant modified graphene was allowed to dry for one day at 60° C. under a vacuum.

### Example 6: Water/Oil Separation Efficiency (%)

The liquid-liquid separation system 100 was used for water-oil separation and evaluated based on the performance thereof. In an example, the water mixed with several oily pollutants was allowed to inlet into the mixing chamber 102 of the system 100. The mixture of oil and water was allowed to flow into the mixing chamber 102 and the oil was collected from the organic phase outlet 114, while the water was collected from the aqueous phase outlet 112. The water was then collected, and the separation efficiency was calculated. The gravity-driven separation efficiency and flux are calculated as by an equation 1 provided below:

$$Separation efficiency ( \% ) = \frac{M}{{M}_{0}} \times 100 \% \qquad ( 1 )$$

where M₀ and M denote the mass of the water before and after separation, respectively.

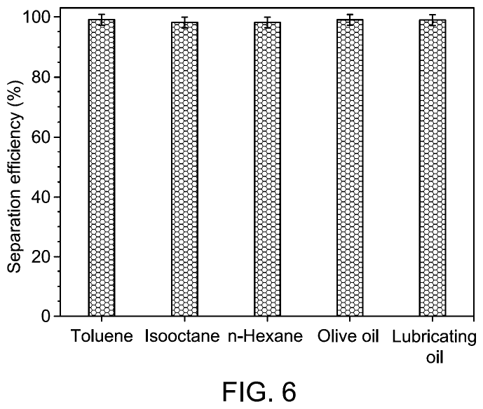

The system displayed high efficiency in water-oil separation. The separation efficiency (%) of the system 100 was evaluated based on a plurality of pollutants including, but are not limited to, toluene, cyclohexane, n-hexane, dichloromethane, and waste oil. The results of the aforementioned evaluation indicative of high separation efficiency are provided in FIG. 6.

Numerous modifications and variations of the present disclosure are possible in light of the above teachings. It is therefore to be understood that within the scope of the appended claims, the invention may be practiced otherwise than as specifically described herein.

1. A liquid-liquid separation system, comprising:
a mixing chamber having a mixture inlet, an aqueous phase outlet and an organic phase outlet;
a hydrophilic separator connected to the aqueous phase outlet and comprising a crown-ether-modified carbon nanomaterial comprising:
a carbon nanomaterial, and
a crown-ether disposed on a surface of the carbon nanomaterial; and
a hydrophobic separator connected to the organic phase outlet and comprising a composite comprising:
fatty acid-modified metal oxide nanoparticles comprising metal oxide nanoparticles having a fatty acid disposed on a surface of the metal oxide nanoparticles, and
a hydrophobic polymer, wherein
the liquid-liquid separation system is configured to receive a mixture stream comprising water and an organic chemical that is not miscible with water supplied to the mixture inlet of the mixing chamber;
the crown-ether-modified carbon nanomaterial is hydrophilic and allows water to pass through the hydrophilic separator while preventing the organic chemical that is not miscible with water from passing through the hydrophilic separator; and
the fatty acid-modified metal oxide nanoparticles are hydrophobic and allow the organic chemical that is not miscible with water to pass through the hydrophobic separator while preventing water from passing through the hydrophobic separator.

2. The liquid-liquid separation system of claim 1, wherein the crown-ether is (18-Crown-6)-2,3,11,12-tetracarboxylic acid.

3. The liquid-liquid separation system of claim 1, wherein the carbon nanomaterial is graphene oxide.

4. The liquid-liquid separation system of claim 1, wherein the crown-ether-modified carbon nanomaterial has a weight ratio of carbon nanomaterial to crown-ether of 1:1 to 2.5:1.

5. The liquid-liquid separation system of claim 1, wherein the hydrophilic separator has an oil contact angle of 125 to 175°.

6. The liquid-liquid separation system of claim 1, wherein the metal oxide nanoparticles are alumina nanoparticles.

7. The liquid-liquid separation system of claim 1, wherein the fatty acid is stearic acid.

8. The liquid-liquid separation system of claim 1, wherein the hydrophobic polymer is polypropylene.

9. The liquid-liquid separation system of claim 1, wherein the hydrophobic separator has a water contact angle of 125 to 175°.

10. The liquid-liquid separation system of claim 1, further comprising a mixer.

11. The liquid-liquid separation system of claim 1, wherein the aqueous phase outlet and the organic phase outlet are arranged in the mixing chamber such that the aqueous phase outlet is oriented at an aqueous outlet height lower than an organic outlet height at which the organic phase outlet is disposed.

12. A method of separating a liquid-liquid mixture comprising an aqueous phase and an organic phase, the method comprising:
introducing the liquid-liquid mixture into the mixing chamber of the liquid-liquid separation system of claim 1;
collecting from the aqueous phase outlet the aqueous phase; and
collecting from the organic phase outlet the organic phase.

13. The method of claim 12, further comprising:
forming the composite comprising fatty acid-modified metal oxide nanoparticles and a hydrophobic polymer by heating a mixture of a metal hydroxide and a fatty acid to form fatty acid-modified metal oxide nanoparticles and mixing the fatty acid-modified metal oxide nanoparticles and the hydrophobic polymer; and
disposing the composite comprising the fatty acid-modified metal oxide nanoparticles and the hydrophobic polymer in the hydrophobic separator.

14. The method of claim 13, wherein
the metal hydroxide is aluminum hydroxide;
the metal oxide nanoparticles are alumina nanoparticles;
the fatty acid is stearic acid; and
the hydrophobic polymer is polypropylene.

15. The method of claim 13, wherein the heating is performed by ultrasonication.

16. The method of claim 12, further comprising:
forming the crown-ether-modified carbon nanomaterial by treating a carbon nanomaterial with an acid and a hydrogen peroxide to form an oxidized carbon nanomaterial and reacting the oxidized carbon nanomaterial with a crown ether carboxylic acid and a carbodiimide catalyst; and
disposing the crown-ether-modified carbon nanomaterial in the hydrophilic separator.

17. The method of claim 16, wherein
the acid is a mixture of phosphoric acid and sulfuric acid;
the carbon nanomaterial is graphene;
the oxidized carbon nanomaterial is graphene oxide;
the crown ether carboxylic acid is (18-Crown-6)-2,3,11,12-tetracarboxylic acid; and
the carbodiimide catalyst is N,N′-Dicyclohexylcarbodiimide.

18. The method of claim 17, wherein the mixture of phosphoric acid and sulfuric acid has a molar ratio of phosphoric acid to sulfuric acid of 0.01:1 to 0.25:1.

19. The method of claim 16, wherein the oxidized carbon nanomaterial with a crown ether carboxylic acid are reacted in a weight ratio of 1:1 to 2.5:1.

20. The method of claim 12, having a separation efficiency of at least 90%.
